(19) United States
(12) Patent Application Publication
(10) Pub. No.: US 2014/0295959 A1
(43) Pub. Date: Oct. 2, 2014

(54) GAME SYSTEM, COMPUTER-READABLE NON-TRANSITORY STORAGE MEDIUM HAVING STORED THEREIN GAME PROGRAM, GAME PROCESSING METHOD, AND GAME APPARATUS

(71) Applicant: NINTENDO CO., LTD., Kyoto (JP)

(72) Inventor: Junya OSADA, Kyoto (JP)

(73) Assignee: NINTENDO CO., LTD., Kyoto (JP)

(21) Appl. No.: 13/901,779

(22) Filed: May 24, 2013

(30) Foreign Application Priority Data
Mar. 28, 2013 (JP) 2013-068699

(51) Int. Cl. A63F 13/00

(52) U.S. Cl. CPC A63F 13/00
USPC 463/31

(57) ABSTRACT

A display screen includes a plurality of display regions. A region occupation ratio of each of the plurality of display regions to a reference that is a single display region occupies an entirety of the display screen is calculated. An output sound volume of a sound associated with each display region is determined on the basis of the region occupation ratio. Then, the sound associated with each display region is outputted in accordance with the determined sound volume.

### CROSS REFERENCE TO RELATED APPLICATION

The disclosure of Japanese Patent Application No. 2013-68699, filed on Mar. 28, 2013, is incorporated herein by reference.

### FIELD

The exemplary embodiments described herein relate to a game system in which a game is played on a display screen displayed on a display device.

### BACKGROUND AND SUMMARY

Hitherto, a game is known in which, when a plurality of players participate in the game and play the game on a display screen displayed on a shared display means, the display screen is split into regions.

In such a game, the split regions of the split screen are assigned to the respective players. In each split region, the corresponding player plays the game in parallel with the other players. Thus, with regard to a sound reproduced in accordance with an operation of each player, such as a sound effect, more sounds are reproduced than those when a single player plays the game. Therefore, the sound volume of the entire sound outputted from a speaker becomes greater than needs.

Therefore, it is a feature of the exemplary embodiments to provide a game system, a computer-readable non-transitory storage medium having stored therein a game program, a game processing method, and a game apparatus which, when a plurality of display regions from each of which a sound is emitted are provided in a screen of a single television (monitor), allow the sound volume of each sound to be controlled such that the entire sound volume is not excessively increased.

In order to attain the feature described above, for example, the following configuration examples are exemplified.

A configuration example is a game system in which a game is played on a display screen displayed on a display device. The display screen includes a plurality of display regions. The game system includes a calculator, a sound volume determination section, and a sound output section. The calculator is configured to calculate a region occupation ratio of each of the plurality of display regions to a reference that is a single display region that occupies an entirety of the display screen. The sound volume determination section is configured to determine an output sound volume of a sound associated with each display region, on the basis of the region occupation ratio calculated by the calculator. The sound output section is configured to output the sound associated with each display region, in accordance with the sound volume determined by the sound volume determination section.

According to the above configuration example, in a game or the like in which a sound corresponding to each of a plurality of display regions is outputted, it is possible to prevent the sound volume of the entire sound, outputted from a speaker or the like, from being excessively increased. In addition, it is possible to output a sound at a volume corresponding to the size of each display region, and it is possible to provide an environment that provides no aural feeling of strangeness.

In another configuration example, the display screen may include a plurality of display regions having unequal sizes.

According to the above configuration example, it is possible to further increase the flexibility in the layout of the plurality of display regions included in the display screen.

In another configuration example, the plurality of display regions included in the display screen may include a main display region and a sub display region arranged so as to be superimposed on the main display region. The game system may further comprise a size change section configured to change a size of the sub display region on the basis of an operation of a player, and the calculator may calculate the region occupation ratio on the basis of the size of the sub display region changed by the size change section.

According to the above configuration example, for example, in a screen in which a window whose size is able to be changed by an operation of the player is displayed so as to be superimposed on a main display region, it is possible to change the sound volume of a sound corresponding to the window, in accordance with size change of the window.

Another configuration example is a game system in which a game is played on a display screen displayed on a display section. The display screen includes a plurality of display regions. The game system includes a calculator, a sound volume determination section, and a sound output section. The calculator is configured to individually recognize sizes of the plurality of display regions and calculate a ratio representing a relative size relation between each display region, on the basis of the size of each display region. The sound volume determination section is configured to determine an output sound volume of a sound associated with each display region, on the basis of the ratio calculated by the calculator. The sound output section is configured to output the sound associated with each display region, in accordance with the sound volume determined by the sound volume determination section.

According to the above configuration example, in a game or the like in which a sound corresponding to each of a plurality of display regions is outputted, it is possible to prevent the sound volume of the entire sound, outputted from a speaker or the like, from being excessively increased.

According to the exemplary embodiments, in a game or the like in which a sound corresponding to each of a plurality of display regions is outputted, while it is possible to prevent the sound volume of the entire sound, outputted from a speaker or the like, from being excessively increased, it is possible to ensure sufficient visibility of a screen for the player playing the game while viewing the screen of a television. Furthermore, it is possible to output a sound at a volume corresponding to the size of each display region, and it is possible to provide an aurally appropriate environment.

### BRIEF DESCRIPTION OF THE DRAWINGS

FIG. 1 is a schematic diagram showing a non-limiting example of the whole image of a game system according to an exemplary embodiment;

FIG. 2 is a block diagram showing a non-limiting example of the configuration of a game apparatus 3;

FIG. 3 is a perspective view showing a non-limiting example of the external configuration of a controller 5;

FIG. 4 is a block diagram showing a non-limiting example of the internal configuration of the controller 5;

FIG. 5 is a diagram showing a non-limiting example of the external configuration of a terminal apparatus 7;

FIG. 6 is a block diagram showing a non-limiting example of the internal configuration of the terminal apparatus 7;

FIG. 7 is a non-limiting example of a game screen during playing by a single player;

FIG. 8 is a non-limiting example of a game screen during simultaneous playing by two players;

FIG. 9 is a non-limiting example of a game screen during simultaneous playing by four players;

FIG. 10 is a non-limiting example of a game screen during simultaneous playing by three players;

FIG. 11 is a diagram showing a non-limiting example of a program and information stored in a memory 12 of the game apparatus 3;

FIG. 12 is a flowchart showing in detail a sound volume setting process according to the embodiment;

FIG. 13 is a non-limiting example of a screen split into three regions;

FIG. 14 is a non-limiting example of a screen split into three regions;

FIG. 15 is a non-limiting example of a screen using a sub-screen; and

FIG. 16 is a non-limiting example of a screen using a sub-screen.

### DETAILED DESCRIPTION OF NON-LIMITING EXAMPLE EMBODIMENTS

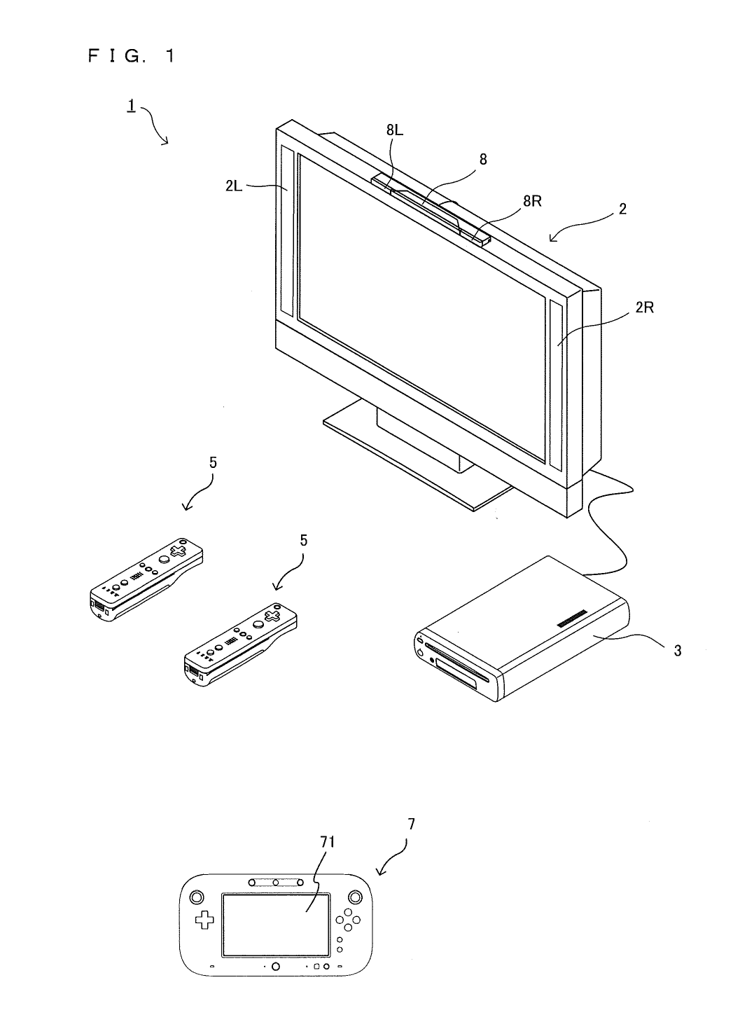

A game system according to an exemplary embodiment will be described with reference to FIG. 1.

In FIG. 1, a game system 1 includes a stationary display device (hereinafter, referred to as “television”) 2 typified by, for example, a television receiver, a stationary game apparatus 3, controllers 5, and a terminal apparatus 7. The game system 1 performs game processing in the game apparatus 3 on the basis of a game operation with each controller 5 and/or the terminal apparatus 7, and displays a game image obtained by the game processing, on the television 2 and/or the terminal apparatus 7.

The television 2 is connected to the game apparatus 3 via a connection cord. The television 2 displays the game image obtained by the game processing performed in the game apparatus 3. The television 2 includes speakers 2L and 2R. The speakers 2L and 2R output a game sound obtained as a result of the game processing. It is noted that in another embodiment, the game apparatus 3 and the stationary display device may be integrated with each other. In addition, communication between the game apparatus 3 and the television 2 may be wireless communication.

The game apparatus 3 performs the game processing or the like on the basis of a game program or the like stored in an optical disc that is readable by the game apparatus 3.

Each controller 5 provides the game apparatus 3 with operation data representing the content of an operation performed on the controller 5 itself. Each controller 5 and the game apparatus 3 are able to communicate with each other by means of wireless communication. The game apparatus 3 is able to communicate with a plurality of controllers, and a plurality of players are allowed to play a game by simultaneously using a predetermined number of controllers. In the present embodiment, the number of the controllers 5 included in the game system 1 is two.

The terminal apparatus 7 has a size small enough to be held by the user, and the user is allowed to move the terminal apparatus 7 with hands or place the terminal apparatus 7 at any location when using the terminal apparatus 7. Although the detailed configuration of the terminal apparatus 7 will be described later, the terminal apparatus 7 includes input means and an LCD (Liquid Crystal Display) 71 as display means. The terminal apparatus 7 and the game apparatus 3 are able to communicate with each other wirelessly (or via wired means). The terminal apparatus 7 receives, from the game apparatus 3, data of an image (e.g., a game image) generated in the game apparatus 3, and displays the image on the LCD 71. In addition, the terminal apparatus 7 transmits, to the game apparatus 3, operation data representing the content of an operation performed on the terminal apparatus 7.

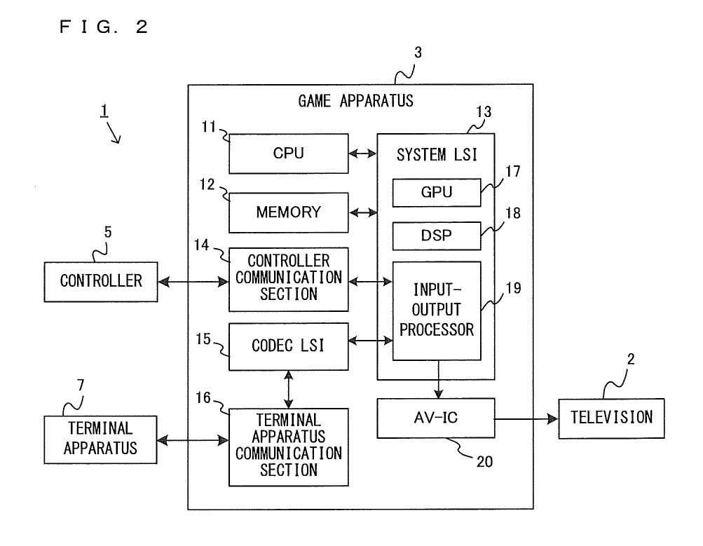

FIG. 2 is a block diagram of the game apparatus 3 that is an example of an information processing apparatus. In FIG. 2, the game apparatus 3 includes a CPU (control section) 11, a memory 12, a system LSI 13, a controller communication section 14, a codec LSI 15, a terminal apparatus communication section 16, an AV-IC (Audio Video-Integrated Circuit) 20, and the like.

The CPU 11 executes a predetermined information processing program (the game program in the present embodiment) by using the memory 12, the system LSI 13, and the like. By so doing, various functions (e.g., the game processing) in the game apparatus 3 are realized. The CPU 11 is connected to the system LSI 13.

The system LSI 13 includes a PGU (Graphics Processor Unit) 17, a DSP (Digital Signal Processor) 18, an input-output processor 19, and the like. The GPU 17 generates an image in accordance with a graphics command (image generation command) from the CPU 11. It is noted that in the present embodiment, the game apparatus 3 generates both a game image to be displayed on the television 2 and a game image to be displayed on the terminal apparatus 7. Hereinafter, the game image to be displayed on the monitor 2 may be referred to as “television game image”, and the game image to be displayed on the terminal apparatus 7 may be referred to as “terminal game image”.

The DSP 18 functions as an audio processor and generates audio data using sound data and acoustic waveform (tone quality) data that are stored in the memory 12.

The input-output processor 19 transmits/receives data to/from components connected thereto, and downloads data from an external apparatus. The input-output processor 19 is connected to the controller communication section 14, the codec LSI 15, and the AV-IC 20. An antenna (not shown) is connected to the controller communication section 14. The codec LSI 15 is connected to the terminal apparatus communication section 16, and an antenna (not shown) is connected to the terminal apparatus communication section 16. In addition, the game apparatus 3 is able to receive operation data from each controller 5. In other words, the input-output processor 19 transmits/receives data to/from each controller 5 via the controller communication section 14. For example, the input-output processor 19 receives operation data transmitted from each controller 5 and stores (temporarily stores) the operation data into a buffer area of the memory 12.

Data of an image and a sound to be outputted in the television 2, among images and sounds generated in the game apparatus 3, is read by the AV-IC 20. The AV-IC 20 outputs the read image data to the television 2 via an AV connector (not shown), and outputs the read audio data via the AV connector to the speakers 2L and 2R included in the television 2. By so doing, the image is displayed on the television 2, and the sound is outputted from the speakers 2L and 2R.

The game apparatus 3 is able to transmit/receive data of images, sounds, and the like to/from the terminal apparatus 7. When transmitting a game image (terminal game image) to the terminal apparatus 7, the input-output processor 19 outputs data of a game image generated by the GPU 17, to the codec LSI 15. The codec LSI 15 performs a predetermined compression process on the image data outputted from the input-output processor 19. The terminal apparatus communication section 16 performs wireless communication with the terminal apparatus 7. Accordingly, the image data compressed by the codec LSI 15 is transmitted by the terminal apparatus communication section 16 to the terminal apparatus 7. In addition to the image data, the game apparatus 3 transmits audio data to the terminal apparatus 7. Specifically, the input-output processor 19 outputs audio data generated by the DSP 18, to the terminal apparatus communication section 16 via the codec LSI 15. Similarly to the image data, the codec LSI 15 also performs a compression process on the audio data. The terminal apparatus communication section 16 transmits the compressed image data and the compressed audio data to the terminal apparatus 7.

The game apparatus 3 is able to receive various data from the terminal apparatus 7. In the present embodiment, the terminal apparatus 7 transmits operation data. Each data transmitted from the terminal apparatus 7 is received by the terminal apparatus communication section 16 and outputted to the input-output processor 19 via the codec LSI 15. The input-output processor 19 stores (temporarily stores) the operation data received from the terminal apparatus 7, into the buffer area of the memory 12.

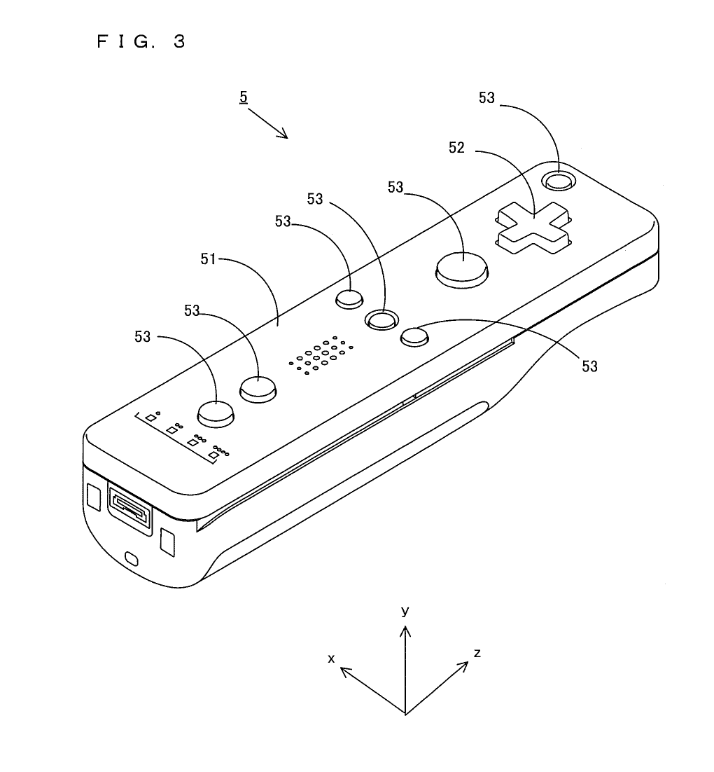

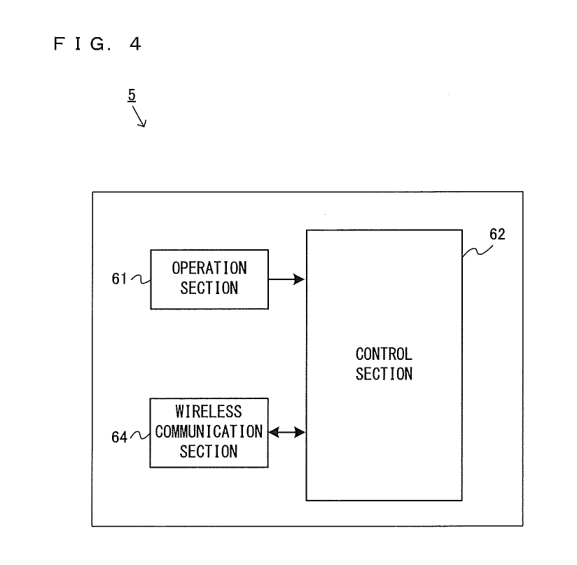

FIG. 3 is a perspective view showing the external configuration of each controller 5. In FIG. 3, the controller 5 includes a housing 51 that is formed by, for example, plastic molding. In addition, the controller 5 includes a cross key 52, a plurality of operation buttons 53, and the like as an operation section (an operation section 61 shown in FIG. 4). The player is allowed to perform a game operation by pressing each button provided in the controller 5.

FIG. 4 is a block diagram showing the internal configuration of each controller 5. As shown in FIG. 4, the controller 5 includes the above-described operation section 61, a control section 62, and a wireless communication section 64. The controller 5 transmits data representing the content of an operation performed on the controller 5, as operation data to the game apparatus 3. Specifically, the operation section 61 outputs, to the control section 62, operation button data representing an input state of each of the above-described cross key 52 and operation buttons 53 (whether each operation button has been pressed). The control section 62 receives the data outputted from the operation section 61, and transmits the received data as operation data to the game apparatus 3 via the wireless communication section 64. Hereinafter, the operation data transmitted by each controller 5 may be referred to as “controller operation data”, and the operation data transmitted by the terminal apparatus 7 may be referred to as “terminal operation data”. In addition, in the present embodiment, wireless communication is performed between each controller 5 and the game apparatus 3, but, in another embodiment, communication may be performed therebetween via wired means.

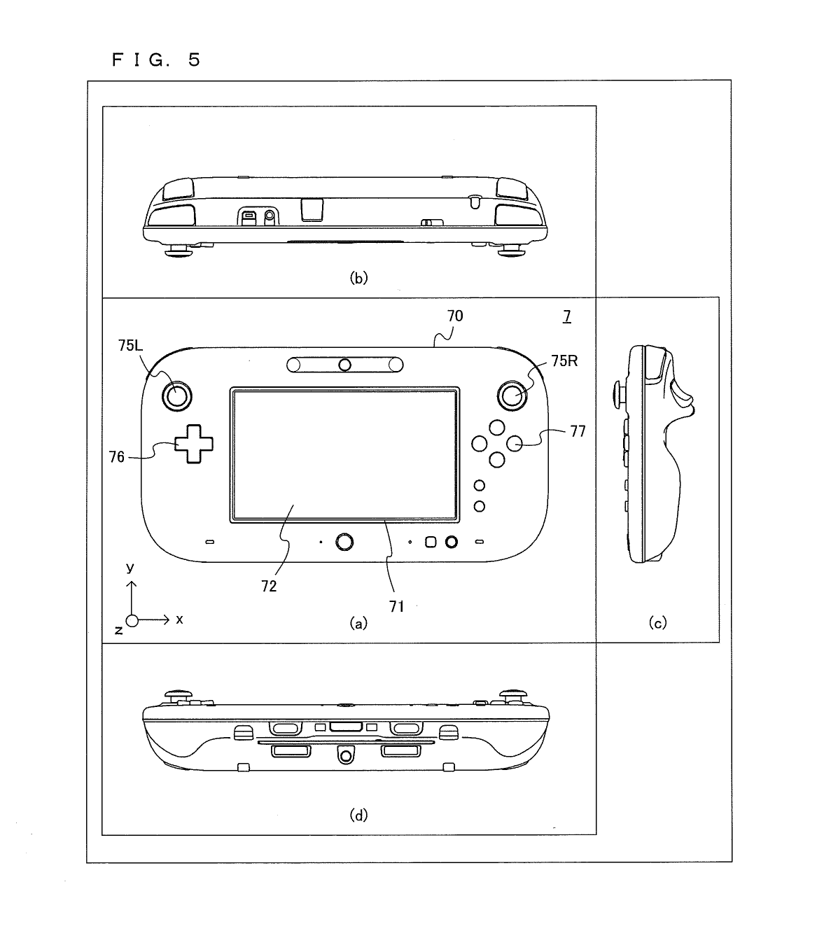

Next, the configuration of the terminal apparatus 7 will be described with reference to FIG. 5. FIG. 5 is a diagram showing the external configuration of the terminal apparatus 7. In FIG. 5, (a) is a front view of the terminal apparatus 7; (b) is a top view of the terminal apparatus 7; (c) is a right side view of the terminal apparatus 7; and (d) is a bottom view of the terminal apparatus 7.

As shown in FIG. 5, the terminal apparatus 7 includes a housing 70 that generally has a plate-like horizontally-long rectangular shape. The housing 70 has a size small enough to be held by the user. Therefore, the user is allowed to move the terminal apparatus 7 with hands or change the location of the terminal apparatus 7.

The terminal apparatus 7 includes the LCD 71 on a front surface of the housing 70. The LCD 71 is provided near the center of the front surface of the housing 70. In addition, the terminal apparatus 7 includes, as one of operations means, a touch panel 72 on the screen of the LCD 71. In the present embodiment, the touch panel 72 is a resistive film type touch panel. However, the touch panel 72 is not limited to the resistive film type touch panel, and any type of a touch panel such as an electrostatic capacitance type may be used.

Furthermore, the terminal apparatus 7 includes, as operation means, analog sticks 75L and 75R, a cross button 76, and a plurality of buttons 77. Each of the analog sticks 75L and 75R is a device for designating a direction. Each of the cross button 76 and the plurality of buttons 77 is operation means for performing a predetermined input.

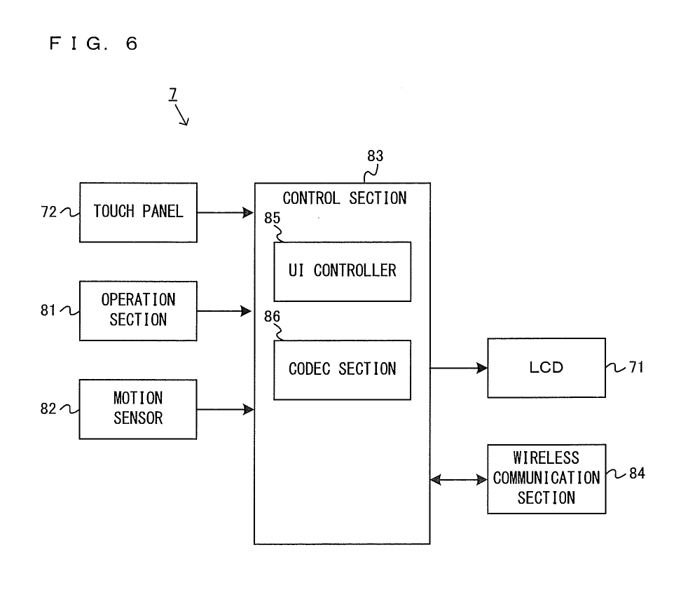

Next, the internal configuration of the terminal apparatus 7 will be described with reference to FIG. 6. FIG. 6 is a block diagram showing the internal configuration of the terminal apparatus 7. As shown in FIG. 6, in addition to the components shown in FIG. 5, the terminal apparatus 7 includes a control section 83, a wireless communication section 84, a motion sensor 82, and the like. These electronic components are mounted on an electronic circuit substrate and accommodated in the housing 70.

The motion sensor 82 is a sensor for detecting the attitude of the terminal apparatus 7. In the present embodiment, an acceleration sensor, an angular velocity sensor, and a magnetic sensor are provided as the motion sensor 82.

The control section 83 includes a UI controller 85, a codec section 86, and the like. The UI controller 85 controls input/output of data to/from various input/output sections. For example, touch position data in a predetermined format is outputted from the touch panel 72. In addition, stick data representing a direction in which the stick part operated by a finger of the user slides (or tilts), and the amount of the sliding (tilting) is outputted from each of the analog sticks 75L and 75R included in an operation section 81 to the UI controller 85. Moreover, operation button data representing an input state of each of the cross button 76 and the plurality of buttons 77 (whether each button has been pressed) is outputted from each of the cross button 76 and the plurality of buttons 77 to the UI controller 85.

The codec section 86 performs a compression process on data to be transmitted to the game apparatus 3, and performs a decompression process on data transmitted from the game apparatus 3. The control section 83 transmits operation data acquired from the touch panel 72, the operation section 81, and the motion sensor 82, as terminal operation data to the game apparatus 3 via the wireless communication section 84. In addition, as described above, compressed image data and compressed audio data are transmitted from the game apparatus 3 to the terminal apparatus 7. These data is transmitted via the wireless communication section 84 to the control section 83. The control section 83 (the codec section 86 thereof) decompresses the received image data and audio data. The decompressed image data is outputted to the LCD 71, and an image based on the image data is displayed on the LCD 71 (a terminal game image is displayed thereon). In addition, the decompressed audio data is outputted to a sound IC (not shown), and the sound IC causes a sound, based on the audio data, to be outputted from a speaker (not shown) (a terminal game sound is outputted therefrom).

Next, an outline of operation of information processing performed in the game system 1 according to the present embodiment will be described. In the processing according to the present embodiment, for example, in a game that is allowed to be played simultaneously by a plurality of players, when so-called screen splitting is performed on one television screen and the game is played, a process of setting a sound volume for each display region (split region) of the split television screen in view of the size of each display region is performed. Specifically, a multiplying factor for the sound volume of a game sound generated from each display region is calculated in accordance with the (region) occupation ratio of each display region to the entire screen of the television 2. Then, when a game sound reproduced for each display region is outputted, a final sound volume is adjusted by using the calculated multiplying factor. In other words, the sound volume of a game sound reproduced in accordance with an operation of each player is changed on the basis of the size of each display region. It is noted that in the following description, a multiplying factor for a sound volume means a multiplying factor with respect to bodily-sensed and aurally-sensed sound volume. For example, doubling a sound volume means control of changing the sound volume to such a degree that the player is allowed to hear a sound at double the sound volume in bodily sensation.

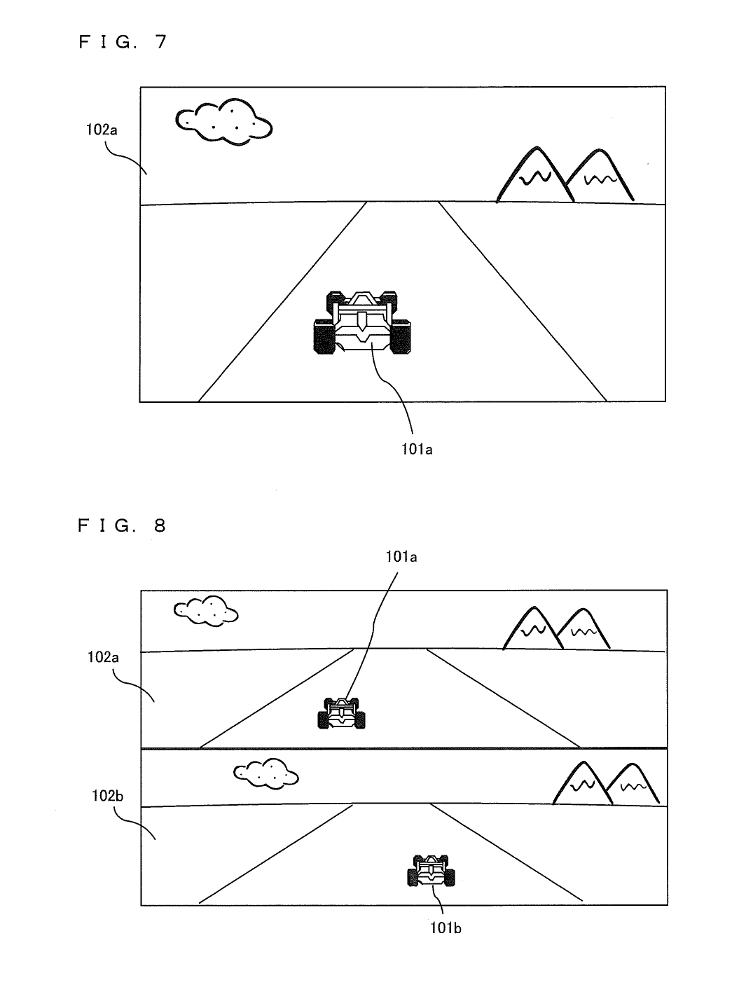

An example of the sound volume setting described above will be described with reference to FIGS. 7 to 10. FIG. 7 is an example of a screen of a game when the screen is not split (during playing by a single player). This game is a racing game, and a virtual game space is displayed on the screen. In addition, a race car object 101a, which is an operation target of the player, is also displayed. This state is also a state where the screen for game playing (the display region) occupies the entire screen of the television 2 at a ratio of 100%. In addition, the race car object 101a is a sound source object that emits a predetermined sound effect (engine sound, etc.). Thus, the sound effect emitted by the race car object 101a is outputted as a game sound (one of game sounds) corresponding to the game screen. In the present embodiment, a multiplying factor for the sound volume of a game sound generated so as to correspond to the game screen in such a state where the screen is not split is set at 1.0.

FIG. 8 is an example of a game screen during simultaneous playing by two players. FIG. 8 shows an example where the screen (display region) is split into upper-half and lower-half regions, and a first display region 102a and a second display region 102b are shown. This state is also a state where the occupation ratio of each display region to the entire screen of the television 2 is 50%. The first display region 102a is the display region on the upper side, and is assigned to a first player. Meanwhile, the second display region 102b is the display region on the lower side, and is assigned to a second player. A game sound generated so as to correspond to each display region is outputted at a sound volume smaller than the sound volume during playing by a single player (when the screen is not split), for example, at 0.7 times that of the sound volume.

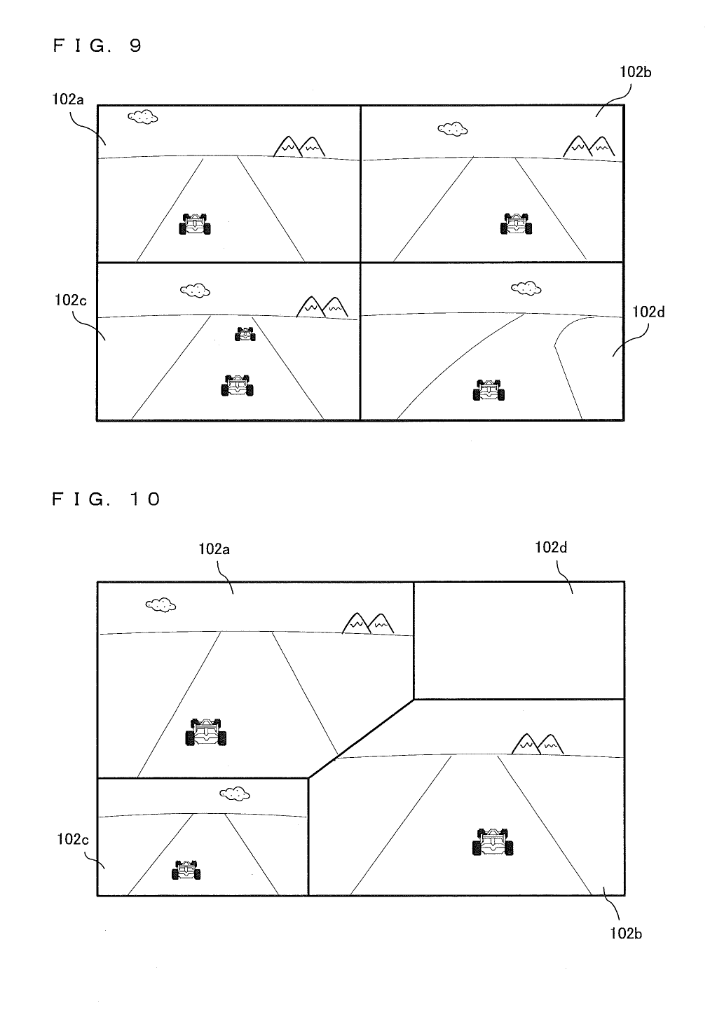

FIG. 9 is an example of a game screen during simultaneous playing by four players. In FIG. 9, the screen is split into four regions (equally split into four regions), and a first display region 102a, a second display region 102b, a third display region 102c, and a fourth display region 102d are shown. In other words, the occupation ratio of each display region to the entire screen of the television 2 is 25%. A game sound generated from each display region in this case is outputted at a sound volume smaller than that during simultaneous playing by two players, for example, at 0.5 times that of the sound volume.

Furthermore, in the present embodiment, as shown in FIG. 10, the screen is also split into display regions having unequal sizes. FIG. 10 is an example of a game screen during simultaneous playing by three players, but four display regions 102a to 102d are shown. The display regions 102c and 102d are smaller in size than the display regions 102a and 102b. Such a split screen is used in the following case. First, the game system 1 according to the present embodiment includes the terminal apparatus 7 as described above. A game screen is displayed also on the LCD 71 of the terminal apparatus 7. The player operating the terminal apparatus 7 is allowed to play the game without viewing the television 2, by operating each operation button of the terminal apparatus 7 while viewing the LCD 71. Thus, for example, a playing manner is conceived of in which, during simultaneous playing by three players, two players (a first player and a second player) operate the controllers 5 and the remaining player (a third player) operates the terminal apparatus 7. In such a case, the screen of the television 2 is split as shown in FIG. 10, and display is performed thereon. Among the four display regions, the display region 102a is assigned to the first player, the display region 102b is assigned to the second player, and the display region 102c is assigned to the third player. In addition, an image that is the same as a game image displayed on the LCD 71 of the terminal apparatus 7 is displayed on the display region 102c. It is noted that no player is assigned to the display region 102d, and the display region 102d is not used directly for game playing. However, information regarding the game, such as a bird's eye view of the entirety of a race course and a display showing the location, on the course, of a race car object operated by each player, may be displayed on this region.

As described above, since the terminal apparatus 7 includes the LCD 71, a screen of the racing game is also displayed on the LCD 71. Thus, it is assumed that the third player operating the terminal apparatus 7 basically plays the game while viewing the LCD 71. Here, in order to allow the first and second players to grasp a game situation of the third player, a game image having the same content as that of a game image displayed on the LCD 71 is displayed on the display region 102c. However, since it is assumed that the third player basically plays the game while viewing the LCD 71, the necessity to provide a large display region for the third player on the screen of the television 2 is low. Thus, as in FIG. 10, the display region 102c is smaller in size than the display regions 102a and 102b. In other words, while the display region 102c is ensured to have such a size that the first and second players are allowed to confirm the situation of the third player on the screen of the television 2, the display regions 102a and 102b are made as large in size as possible such that both players are allowed to easily view their assigned screens.

Also for the screen as shown in FIG. 10, a multiplying factor for a final-output sound volume of a game sound for each display region is set in accordance with each display region, specifically, the occupation ratio of each of the display regions 102a to 102c to the entire screen (it is noted that here, no game sound corresponding to the display region 102d is outputted). For example, the multiplying factor for each of the display regions 102a and 102b is set at 0.7, and the multiplying factor for the display region 102c is set at 0.5.

As described above, in the present embodiment, when screen splitting is used, a final output sound volume of a game sound corresponding to each display region is set on the basis of the occupation ratio of each display region to the entire screen. By so doing, while it is possible to prevent the sound volume of the entire sound, outputted from the speakers 2L and 2R (the sum of the sound volumes of the game sounds corresponding to the respective display regions), from being excessively increased, it is possible to ensure sufficient visibility of the screen for each player playing the game while viewing the screen of the television 2. Furthermore, it is possible to output a sound at a volume corresponding to the size of each display region, and it is possible to provide an aurally appropriate environment. In particular, this method is useful for a case of using unequal screen splitting as shown in FIG. 10.

It is noted that with regard to the multiplying factor for the final-output sound volume, other than the method for setting a multiplying factor on the basis of the occupation ratio to the entire screen as described above, for example, a multiplying factor may be set on the basis of the size ratio (a relative size relation) between each display region. Specifically, the surface area of each display region may be calculated. Then, these surface areas may be compared and the relative size ratio between each display region may be calculated. On the basis of this ratio, a multiplying factor for a final-output sound volume may be set.

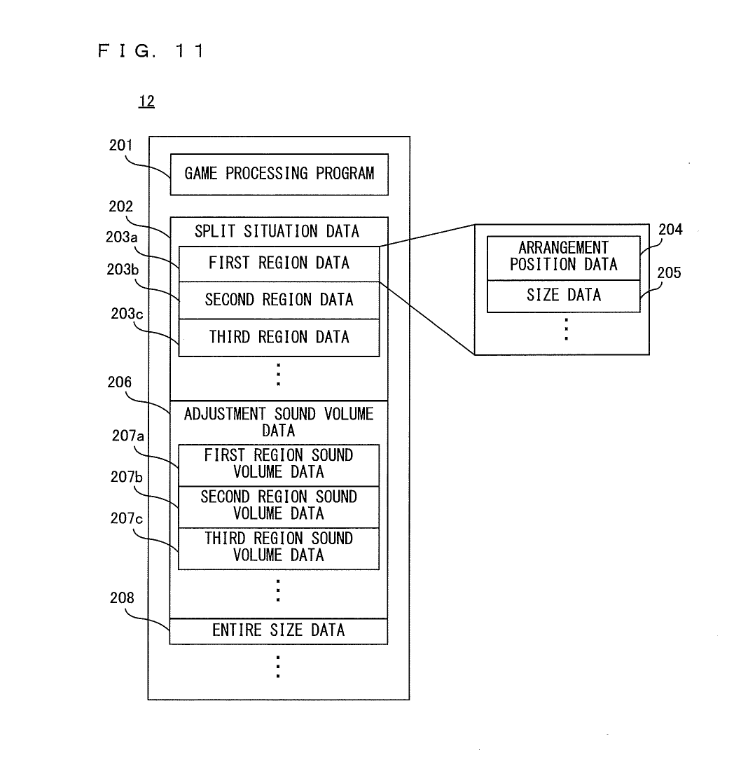

Next, an operation of the game apparatus 3 according to the present embodiment will be described in more detail with reference to FIGS. 11 and 12.

FIG. 11 shows an example of a program and information stored in the memory 12 of the game apparatus 3. A game processing program 201, split situation data 202, adjustment sound volume data 206, entire size data 208, and the like are stored in the memory 12. In addition, operation data from each controller 5 and the terminal apparatus 7, data of each object, and the like are also stored in the memory 12 according to need.

The game processing program 201 is a program for performing game processing including a sound volume setting process as described above.

The split situation data 202 is data for representing a split situation of the screen of the television 2. The split situation data 202 includes nth region data 203 corresponding to the number of display regions. The number of the nth region data 203 is increased or decreased as appropriate in accordance with the number of regions into which the screen is split (the number of display regions). In the example of FIG. 11, in the split situation data 202, first region data 203a, second region data 203b, and third region data 203c (hereinafter, they may be collectively referred to as nth region data) are shown. The nth region data 203 includes data for representing the arrangement position of each display region, its size, and the like. Specifically, the nth region data 203 each includes arrangement position data 204, size data 205, and the like. The arrangement position data 204 is data representing, for example, a coordinate at which the upper left corner of each region is located. The size data 205 is data representing, for example, the vertical and horizontal lengths of each display region 102. These data is obtained by copying from a table (not shown) into the nth region data 203 as appropriate, for example, when the player selects dual-screen playing in playing the game (when a split screen is generated). This table is previously created as a part of game data, and, for example, an arrangement position and a size of each region when the screen is split into two regions are defined therein.

In addition, the split situation data 202 may also include data representing the number of display regions (the number of regions into which the screen is split), and the like.

The adjustment sound volume data 206 is data for adjusting a final sound volume of a game sound corresponding to each display region. The adjustment sound volume data 206 includes nth region sound volume data 207 corresponding to the number of display regions. In the example of FIG. 11, first region sound volume data 207a, second region sound volume data 207b, and third region sound volume data 207c are included. In each nth region sound volume data, for example, data representing a multiplying factor for a sound volume as described above can be stored.

The entire size data 208 is data for representing the size of the entire screen of the television 2. In other words, the entire size data 208 is data for representing the size of a display region whose occupation ratio to the entire screen of the television 2 is 100%.

Next, flow of a process performed by the CPU 11 of the game apparatus 3 will be described with reference to a flowchart in FIG. 12. It is noted that here, a process (sound volume setting process) of setting a sound volume for each display region of a split screen will be mainly described, and the detailed description of other processes not directly related to the present embodiment is omitted. In addition, a process of splitting the screen (a process of forming a plurality of display regions) is performed by the CPU 11 prior to execution of the flowchart. Moreover, a process loop composed of a series of processes in steps S1 to S4 in FIG. 12 is repeatedly performed every predetermined time period (one-frame time period).

In step S1, the CPU 11 refers to the split situation data 202 and grasps the situation of screen splitting.

Next, in step S2, the CPU 11 refers to the entire size data 208 and the nth region data 203 corresponding to each display region, and calculates the occupation ratio of each display region to the entire screen.

Next, in step S3, the CPU 11 determines a multiplying factor for a final sound volume for each display region on the basis of the calculation result of the occupation ratio, and stores the multiplying factor as the adjustment sound volume data 206 into the memory 12. The multiplying factor may be determined by performing calculation using a predetermined mathematical formula, or by reading from a table that is previously prepared as a part of game data and defines correspondence between an occupation ratio and a multiplying factor for a sound volume (e.g., “an occupation ratio of 50% is associated with 0.7 times that of the sound volume”).

It is noted that in another embodiment, a multiplying factor for a sound volume may be determined on the basis of a relative size relation between each display region, instead of the occupation ratio to the entire screen. For example, the CPU 11 calculates the size ratio between each display region on the basis of the size of each display region (the calculation is performed, for example, where: the size of the first display region is set at “1” (reference); the size of the second display region is “1” times that of the reference size; and the size of the third display region is “0.7” times that of the reference size.) Then, a multiplying factor for a sound volume may be determined on the basis of this ratio.

Next, in step S4, the CPU 11 outputs a game sound corresponding to each display region. For example, the CPU 11 collects sound effects emitted by race car objects 101 (sound source objects) within a virtual space, by using virtual microphones assigned to the respective players (virtual microphones of which the number is the same as the number of the players who are simultaneously playing the game are prepared.), and generates a game sound for each display region. Then, the CPU 11 outputs the generated game sound to the speakers 2L and 2R. At that time, the CPU 11 refers to the adjustment sound volume data 206, adjusts a final sound volume of the game sound corresponding to each display region, and outputs the game sound to the speakers 2L and 2R. By so doing, the game sound is outputted from the speakers 2L and 2R at a sound volume corresponding to the size of each display region. This is the end of the sound volume setting process.

As described above, in the present embodiment, when the screen is split, the sound volume of a game sound corresponding to each display region is controlled on the basis of the occupation ratio of each display region to the entire screen. By so doing, the sound volume of a sound outputted from the speakers 2L and 2R is prevented from being excessively increased, and it is possible to output a game sound or the like corresponding to each display region, at a sound volume that corresponds to the size of each display region and provides no feeling of strangeness.

It is noted that when three of four display regions are used as screens for playing as shown in FIG. 10, the process may be performed on only display regions from which sounds are emitted (the display regions 102a to 102c in the example of FIG. 10), as targets of the sound volume setting, or regardless of whether or not a sound is emitted, the occupation ratio may be calculated for each of all the display regions (the display regions 102a to 102d in the example of FIG. 10) and a sound volume multiplying factor may be determined on the basis of the occupation ratio (in this case, there is a display region for which a multiplying factor is determined but from which no sound is actually outputted).

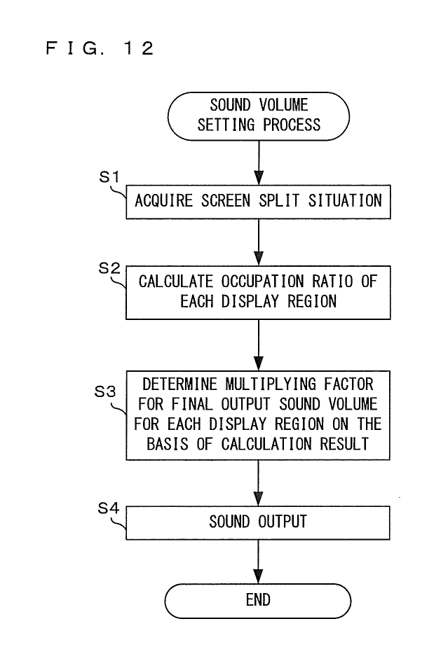

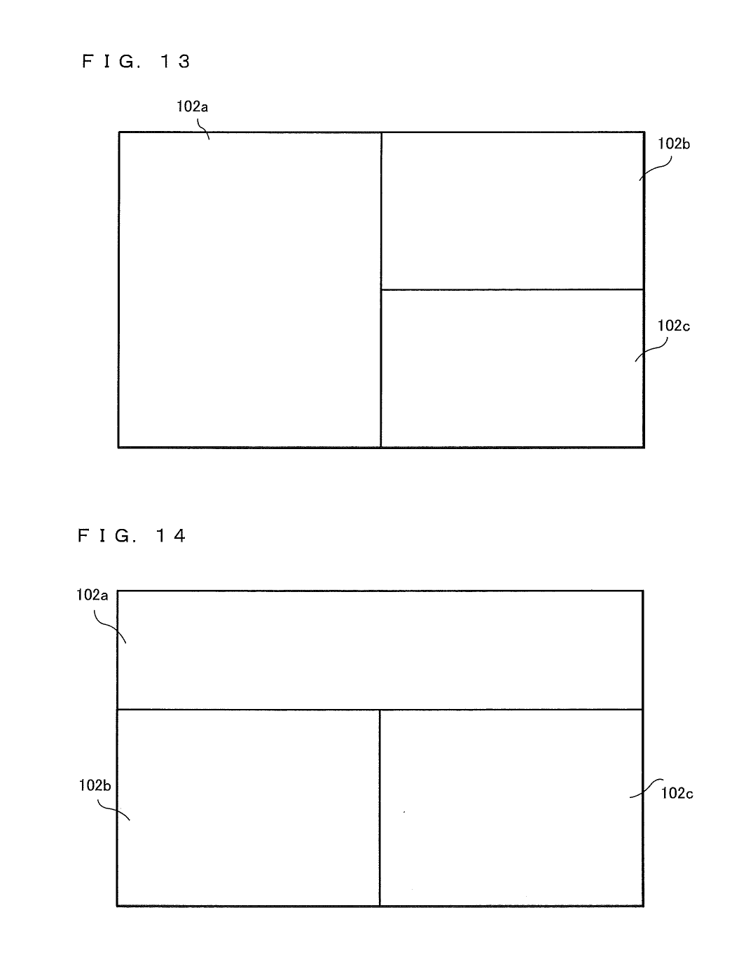

It is needless to say that the above process is also applicable to a case where the screen is split into three screens as shown in FIG. 13 or 14. In addition, it is needless to say that the above process is also applicable to a case where the screen is split into five or more screens.

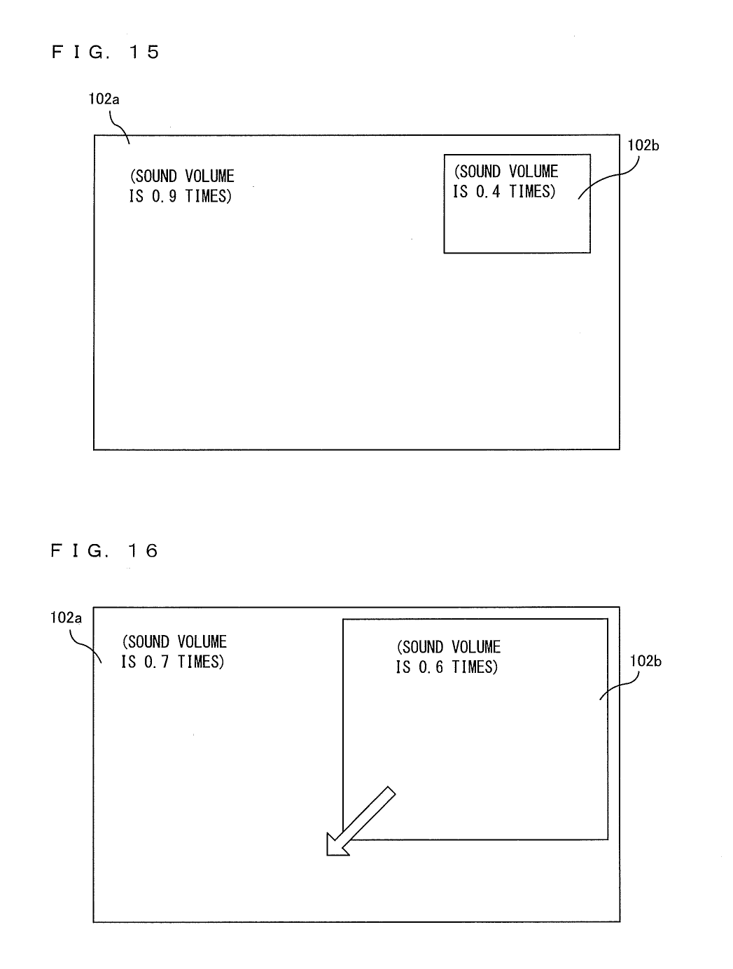

In addition, other than screen splitting for playing by a plurality of players, for example, with regard to an application or the like having a display region such as a sub-screen in a part of a screen as shown in FIG. 15, it is also possible to perform sound volume control in accordance with the size (occupation ratio) of the sub-screen when the above process is applied to the application or the like.

In addition, the process in the above embodiment may be applied to a case where this sub-screen is, for example, a window, namely, a case where a second display region (sub-screen) is superimposed on a first display region. Furthermore, the size of the second display region may be able to be changed on the basis of an operation of the player or the like. In this case, a multiplying factor for the sound volume of a game sound corresponding to the second display region may be changed as appropriate in accordance with size change of the second display region (i.e., change of the occupation ratio to the entire screen). For example, in the case where a sound volume multiplying factor for a first display region 102a is set at 0.9 and a sound volume multiplying factor for a second display region 102b is set at 0.4 in the example of FIG. 15, when the size of the second display region 102b is increased as shown in FIG. 16, each multiplying factor may be changed such that the sound volume multiplying factor for the first display region 102a is changed to 0.7 and the sound volume multiplying factor for the second display region 102b is changed to 0.6. As the size of the second display region is caused to approach the size of the entire screen, the sound volume multiplying factor of the first display region may be decreased, and the sound volume multiplying factor for the second display region may be caused to approach 1. More specifically, in the process in step S1 in FIG. 12, the sizes of the first and second display regions at that time may be acquired, and in step S2, the occupation ratio of each display region may be calculated.

Although described above, a sound volume multiplying factor may be determined on the basis of, for example, a relative size relation between each display region. In this case, in step S2 in FIG. 12, the size of each display region, e.g., the surface area thereof, may be calculated, and a ratio representing the relative size relation between each display region may be calculated on the basis of the size of each display region. Then, in step S3, a multiplying factor for a sound volume for each display region may be set on the basis of the relative size relation.

In the above embodiment, a series of processes for setting a sound volume in accordance with the size of each display region is performed in a single apparatus. In another embodiment, the series of processes may be performed in an information processing system that includes a plurality of information processing apparatuses. For example, in an information processing system that includes a terminal side apparatus and a server side apparatus capable of communicating with the terminal side apparatus via a network, a part of the series of processes may be performed by the server side apparatus. Alternatively, in an information processing system that includes a terminal side apparatus and a server side apparatus capable of communicating with the terminal side apparatus via a network, a main process of the series of the processes may be performed by the server side apparatus, and a part of the series of the processes may be performed by the terminal side apparatus. Still alternatively, in the information processing system, a server side system may include a plurality of information processing apparatuses, and a process to be performed in the server side system may be divided and performed by the plurality of information processing apparatuses.

What is claimed is:

1. A game system in which a game is played on a display screen displayed on a display device, the display screen including a plurality of display regions, the game system comprising:
a calculator configured to calculate a region occupation ratio of each of the plurality of display regions to a reference that is a single display region that occupies an entirety of the display screen;
a sound volume determination section configured to determine an output sound volume of a sound associated with each display region, on the basis of the region occupation ratio calculated by the calculator; and
a sound output section configured to output the sound associated with each display region, in accordance with the sound volume determined by the sound volume determination section.

2. The game system according to claim 1, wherein the display screen includes a plurality of display regions having unequal sizes.

3. The game system according to claim 1, wherein
the plurality of display regions included in the display screen include a main display region and a sub display region arranged so as to be superimposed on the main display region,
the game system further comprises a size change section configured to change a size of the sub display region on the basis of an operation of a player, and
the calculator calculates the region occupation ratio on the basis of the size of the sub display region changed by the size change section.

4. A game system in which a game is played on a display screen displayed on a display section, the display screen including a plurality of display regions, the game system comprising:
a calculator configured to individually recognize sizes of the plurality of display regions and calculate a ratio representing a relative size relation between each display region, on the basis of the size of each display region;
a sound volume determination section configured to determine an output sound volume of a sound associated with each display region, on the basis of the ratio calculated by the calculator; and
a sound output section configured to output the sound associated with each display region, in accordance with the sound volume determined by the sound volume determination section.

5. The game system according to claim 4, wherein the display screen includes a plurality of display regions having unequal sizes.

6. A computer-readable non-transitory storage medium having a game program stored therein, the game program being executed by a computer of a game system in which a game is played on a display screen displayed on a display device, the display screen including a plurality of display regions, the game program causing the computer to operate as:
a calculator configured to calculate a region occupation ratio of each of the plurality of display regions to a reference that is a single display region that occupies an entirety of the display screen;
a sound volume determination section configured to determine an output sound volume of a sound associated with each display region, on the basis of the region occupation ratio calculated by the calculator; and
a sound output section configured to output the sound associated with each display region, in accordance with the sound volume determined by the sound volume determination section.

7. A game processing method for controlling a game system in which a game is played on a display screen displayed on a display device, the display screen including a plurality of display regions, the game processing method comprising the steps of:
calculating a region occupation ratio of each of the plurality of display regions to a reference that is a single display region that occupies an entirety of the display screen;
determining an output sound volume of a sound associated with each display region, on the basis of the region occupation ratio calculated in the calculating step; and
outputting the sound associated with each display region, in accordance with the sound volume determined in the determining step.

8. A game apparatus in which a game is played on a display screen displayed on a display device, the display screen including a plurality of display regions, the game apparatus comprising:
a calculator configured to calculate a region occupation ratio of each of the plurality of display regions to a reference that is a single display region that occupies an entirety of the display screen;
a sound volume determination section configured to determine an output sound volume of a sound associated with each display region, on the basis of the region occupation ratio calculated by the calculator; and
a sound output section configured to output the sound associated with each display region, in accordance with the sound volume determined by the sound volume determination section.

9. A computer-readable non-transitory storage medium having a game program stored therein, the game program being executed by a computer of a game system in which a game is played on a display screen displayed on a display section, the display screen including a plurality of display regions, the game program causing the computer to operate as:
a calculator configured to individually recognize sizes of the plurality of display regions and calculate a ratio representing a relative size relation between each display region, on the basis of the size of each display region;
a sound volume determination section configured to determine an output sound volume of a sound associated with each display region, on the basis of the ratio calculated by the calculator; and
a sound output section configured to output the sound associated with each display region, in accordance with the sound volume determined by the sound volume determination section.

10. A game processing method for controlling a game system in which a game is played on a display screen displayed on a display section, the display screen including a plurality of display regions, the game processing method comprising the steps of:
individually recognizing sizes of the plurality of display regions and calculating a ratio representing a relative size relation between each display region, on the basis of the size of each display region;
determining an output sound volume of a sound associated with each display region, on the basis of the ratio calculated in the calculating step; and
outputting the sound associated with each display region, in accordance with the sound volume determined in the determining step.

11. A game apparatus in which a game is played on a display screen displayed on a display section, the display screen including a plurality of display regions, the game apparatus comprising:
a calculator configured to individually recognize sizes of the plurality of display regions and calculate a ratio representing a relative size relation between each display region, on the basis of the size of each display region;
a sound volume determination section configured to determine an output sound volume of a sound associated with each display region, on the basis of the ratio calculated by the calculator; and
a sound output section configured to output the sound associated with each display region, in accordance with the sound volume determined by the sound volume determination section.
